(19) United States
(12) Patent Application Publication
(10) Pub. No.: US 2006/0082525 A1
(43) Pub. Date: Apr. 20, 2006

(54) Drive device for light-emitting display panel and electronic machine on which the device is mounted

(75) Inventors: Naoto Suzuki, Yonezawa-shi (JP); Shuichi Seki, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 11/248,148

(22) Filed: Oct. 13, 2005

(30) Foreign Application Priority Data
Oct. 18, 2004 (JP) 2004-302835

(51) Int. Cl. G09G 3/30

(52) U.S. Cl. 345/77

(57) ABSTRACT

A drive device for a light-emitting display panel in which pixels respectively including light-emitting elements are arranged at crossing positions of a plurality of data lines and a plurality of scanning selection lines in the form of a matrix. A 1-frame period is time-divided into a plurality of sub-frame periods, grayscale bits for setting ON periods are allocated to the sub-frames, respectively, to perform weighting, grayscale display is performed by summing the ON periods of the sub-frames, and a frame frequency of the 1-frame period is set within a range of 100 Hz to 150 Hz.

### BACKGROUND OF THE INVENTION

1. Field of the Invention

The present invention relates to a drive device for a display panel for actively driving a light-emitting element constituting a pixel by a TFT (Thin Film Transistor), and to a drive device for a display panel which can reduce moving image pseudo noise generated when, for example, a 1-frame period is time-divided into a plurality of sub-frames, and brightness weights are given to the sub-frames to perform many grayscale expression and an electronic machine on which the device is mounted.

2. Description of the Related Art

Along with the popularization of a mobile telephone and a personal digital assistant (PDA), a demand for a display panel which can realize a small thickness or a low power consumption increases. As a display panel which satisfies the demand, a conventional liquid crystal panel is applied to a large number of products. On the other hand, in recent years, a display panel using an organic EL element which takes advantage of characteristics of a light-emitting display element is practically used. The display panel draws attention as a next-generation display panel alternative to a conventional liquid display panel. This is caused by the background that an organic compound promising preferable light-emitting characteristics is used in a light-emitting layer of an element to achieve high efficiency and long life which are enough to practically use the element.

The organic EL element is basically formed such that a transparent electrode consisting of, e.g., ITO, a light-emitting function layer, and a metal electrode are sequentially stacked on a transparent substrate such as a glass substrate. The light-emitting function layer may be a single layer consisting of an organic light-emitting layer, a two-layer structure consisting of an organic hole transportation layer and an organic light-emitting layer, a three-layer structure consisting of an organic hole transportation layer, an organic light-emitting layer, an organic electron transportation layer, or a multi-layer structure obtained by inserting an electron- or hole-implanted layer between the appropriate layers.

As a display panel using the organic EL element, an active matrix display panel obtained by adding active elements constituted by, e.g., TFTs to EL elements arranged in the form of a matrix is proposed. The active matrix display panel can achieve a low power consumption. Furthermore, the active matrix display panel has a characteristic feature such as a small crosstalk between pixels, and is especially suitable for a high-definition display having a large screen.

FIG. 1 shows an example of a circuit arrangement corresponding to one conventional active matrix display panel 10. This pixel arrangement shows a most basic conductance-controlled circuit arrangement obtained when organic EL elements are used as light-emitting pixels.

In the arrangement of the pixels 11, a data signal Vdata corresponding to a video signal from a data driver 12 is designed to be supplied to a source of a scanning selection transistor, i.e., a data write transistor Tr2 through a data line A1 arranged on the display panel 10. A scanning selection signal Select is designed to be supplied from a scanning drive 13 to the gate of the scanning selection transistor Tr2 through a scanning selection line B1.

The drain of the scanning selection transistor Tr2 is connected to the gate of a light-emitting drive transistor Tr1 and connected to one end of a light-emission maintaining capacitor C1. The source of the light-emitting drive transistor Tr1 is connected to the other end of the capacitor C1 and connected to an anode side power supply line Va. The drain of the light-emitting drive transistor Tr1 is connected to an anode terminal of an organic EL element E1 serving as a light-emitting element, and the cathode terminal of the organic EL element E1 is connected to a cathode side power supply line Vc.

In the pixel 11 shown in FIG. 1, the scanning selection transistor Tr2 is constituted by an n-channel TFT, and-the light-emitting drive transistor Tr1 is constituted by a p-channel TFT. FIG. 1 shows only one pixel arrangement due to limitations of space. However, the pixels 11 of the pixel arrangement are arranged at positions of crossing points between data lines and scanning selection lines aligned in row and column directions to constitute a dot matrix display panel 10.

In the arrangement of the pixels 11 shown in FIG. 1, an ON voltage Select serving as a scanning signal is supplied from the scanning drive 13 to the gate of the scanning selection transistor Tr2 in an address period. In this manner, a current corresponding to the data signal Vdata supplied from the data driver 12 flows into the light-emission maintaining capacitor C1 through the source/drain of the scanning selection transistor Tr2 to charge the capacitor C1.

The charging voltage is supplied to the gate of the light-emitting drive transistor Tr1. The light-emitting drive transistor Tr1 causes a drain current Id based on a gate-source voltage (Vgs) generated by the gate voltage and a voltage supplied from the anode side power supply line Va to the source to flow into the EL element E1, so that the EL element E1 emits light.

After the address period has elapsed, when the voltage of the gate of the scanning selection transistor Tr2 is turned off, the transistor Tr2 is set in a cutoff state. However, the gate voltage of the light-emitting drive transistor Tr1 is held by electronic charges accumulated in the capacitor C1, so that a drive current to the EL element E1 is maintained. Therefore, in a period of time until the next address operation is started (for example, in the next 1-frame period or the next 1-sub-frame period), the EL element E1 can continue an ON state corresponding to the data signal Vdata.

As a method of performing grayscale display of image data by using the above circuit arrangement, a time grayscale scheme is proposed. In the time grayscale scheme, for example, a 1-frame period is time-divided into a plurality of sub-frame periods, and gradation display is performed by summing sub-frame periods in which the EL elements emit light in a 1-frame period.

The time grayscale scheme includes a method (conveniently called a simple sub-frame method) in which, as shown in FIG. 2, the EL elements are driven to emit light in units of sub-frames to perform grayscale expression by simply summing sub-frame periods in which the EL elements emit light, and a method (conveniently called a weighting sub-frame method) in which, as shown in FIG. 3, grayscale bits are allocated to combinations each consisting of a 1-sub-frame period or a plurality of sub-frame period to perform weighting to perform grayscale expression by the combinations. Both FIGS. 2 and 3 exemplify cases in which 8 grayscales including grayscales “0” to “7” are expressed.

Of these methods, the weighting sub-frame method shown in FIG. 3 has the following advantage. That is, for example, weighting control for grayscale display even in an ON period in a sub-frame period, so that many grayscale display can be realized by sub-frames the number of which is smaller than that in the simple sub-frame method. However, in the weighting sub-frame method, since grayscales are expressed by combinations of time-discrete light emission to a 1-frame image, contour-like noise called moving image pseudo contour noise (to be simply referred to as pseudo contour noise hereinafter) may be generated as a cause of deterioration of image quality.

The pseudo contour noise will be described below with reference to FIG. 4. FIG. 4 is a diagram for explaining a mechanism that generates pseudo contour noise. In FIG. 4, four combinations (combination 1 to combination 4) of sub-frames weighted (weights 1, 2, 4 and 8) by brightnesses of powers of two are arranged in an ascending order of brightnesses.

An image in which brightnesses increases (becomes bright) step by step in units of pixels downwardly on a display screen, i.e., an image in which brightnesses smoothly change is considered, it is assumed that the image upwardly moves by one pixel after a 1-frame period has passed. As shown in FIG. 4, although display positions of frame 1 and frame 2 on the screen are shifted from each other by one pixel, a joint line between the frames in image moving cannot be recognized by human eyes.

However, since human eyes naturally follow moving brightness, the human eyes follow a combination of sub-frames in which pixels do not emit light between brightness 7 and brightness 8 between which light-emitting patterns widely changes, and the human eyes see the pixels as if a black pixel having a brightness of 0 moves. Therefore, the human eyes recognize brightnesses which are not essentially present and perceive the brightnesses as noise contour-like noise. When the same grayscale data are displayed on the same pixel in these continuous frames, pseudo contour noise is easily generated when the light-emitting patterns in the frames are the same.

As a countermeasure against these problems, a method replacing display orders of combinations of weighted sub-frames in each frame can be used. In the example shown in FIG. 5, in two continuous frames (set as the first frame and the second frame), display orders of weighted combinations are made different from each other. More specifically, in the first frame, combinations are displayed in order named: weight 4, weight 2, and weight 1. In the second frame, the combinations are displayed in order named: weight 1, weight 4, and weight 2. In this manner, the same grayscale data in the continuous frames may have different light-emitting patterns, and pseudo contour noise can be suppressed from being generated to some extent.

In order to suppress the moving image pseudo contour noise from being suppressed, grayscale display obtained by devising the light-emitting pattern of one frame data is also disclosed in Japanese Patent Application Laid-Open No. 2001-125529 described below.

When the method shown in FIG. 5 is employed, control is performed such that light-emitting patterns of the same pixel in continuous frames are different from each other. For this reason, feeling of pseudo contour noise in human sense can be reduced to some extent. However, even though light-emitting patterns are arranged in any manner, when the weighting sub-frame method is employed, the principle of grayscale expression by combinations of time-discrete light emission does not change. Therefore, the pseudo contour noise cannot be completely suppressed from being generated.

On the other hand, in the simple sub-frame method, in light emission in a 1-frame period, light emission in a plurality of sub-frame periods is not considerably discrete. For this reason, the pseudo contour noise can be suppressed from being generated. However, in the simple sub-frame method, light emission is simply performed in a 1-sub-frame period or a plurality of sub-frame periods to perform grayscale display. For this reason, in order to realize grayscale display equivalent to that of the weighting sub-frame method, a 1-frame period must be divided into a large number of sub-frame periods. In this case, a basic clock frequency at which the circuit is driven must be set high, a load acting on a drive system peripheral circuit in high-speed drive becomes high, and a problem that a low power consumption cannot be realized is posed.

Generation of the pseudo contour noise can be roughly classified into a first aspect in which pseudo contour noise is generated by actual moving image display and a second aspect in which the pseudo contour noise is generated by moving a display screen itself by hand shaking or the like. The pseudo contour noise caused by hand shaking as the second aspect is generated when a user looks at a device such as a mobile device while holding the device with her/his hand. The noise is generated by an interaction between motion of the device and motion of human eyes following the device.

The pseudo contour noise generated in the first aspect, as shown in FIG. 5, can be advantageously reduced to some extent by employing a method of changing arrangements of light-emitting patterns in respective frames. However, the present inventor acquires the following fact by an experiment or the like. That is, with respect to the pseudo contour noise generated in the second aspect, an advantageous reduction in noise cannot be considerably expected even though the method shown in FIG. 5 is employed.

### SUMMARY OF THE INVENTION

The present invention has been made in consideration of the technical problems described above, and has as its object to provide a drive device for a display panel which can effectively reduce pseudo contour noise generated by the first aspect and the second aspect while employing grayscale control by the weighting sub-frame method and an electronic machine on which the device is mounted.

In order to solve the above problems, according to the present invention, there is provided a drive device for a light-emitting display panel in which pixels respectively including light-emitting elements are arranged at crossing positions of a plurality of data lines and a plurality of scanning selection lines in the form of a matrix, a 1-frame period is time-divided into a plurality of sub-frame periods, grayscale bits for setting ON periods are allocated to the sub-frames, respectively, to perform weighting, grayscale display is performed by summing the ON periods of the sub-frames, and a frame frequency of the 1-frame period is set within a range of 100 Hz to 150 Hz.

### BRIEF DESCRIPTION OF THE DRAWINGS

FIG. 1 is a circuit diagram showing an arrangement of pixels by a conventional conductance-controlled drive method;

FIG. 2 is a timing chart for explaining a grayscale scheme by a simple sub-frame method;

FIG. 3 is a timing chart for explaining a grayscale scheme by a weighting sub-frame method;

FIG. 4 is a diagram for explaining a mechanism of generation of pseudo contour noise;

FIG. 5 is a timing chart for explaining a countermeasure to reduce pseudo contour noise;

FIG. 6 is a circuit diagram showing a pixel arrangement used in an embodiment of the present invention;

FIG. 7 is a circuit diagram for explaining a unit for applying a reverse bias voltage to a pixel;

FIG. 8 is a timing chart showing an example in which grayscale bits are allocated to time-divided sub-frames;

FIG. 9 is a timing chart for explaining the first embodiment according to the present invention;

FIG. 10 is a block diagram showing an example of a frame rate converting unit used in the embodiment shown in FIG. 9;

FIG. 11 is a timing chart for explaining a second embodiment according to the present invention;

FIG. 12 is a timing chart for explaining a third embodiment;

FIG. 13 is a timing chart for explaining a fourth embodiment;

FIG. 14 is a timing chart for explaining a fifth embodiment; and

FIG. 15 is a timing chart for explaining a sixth embodiment.

### DESCRIPTION OF THE PREFERRED EMBODIMENTS

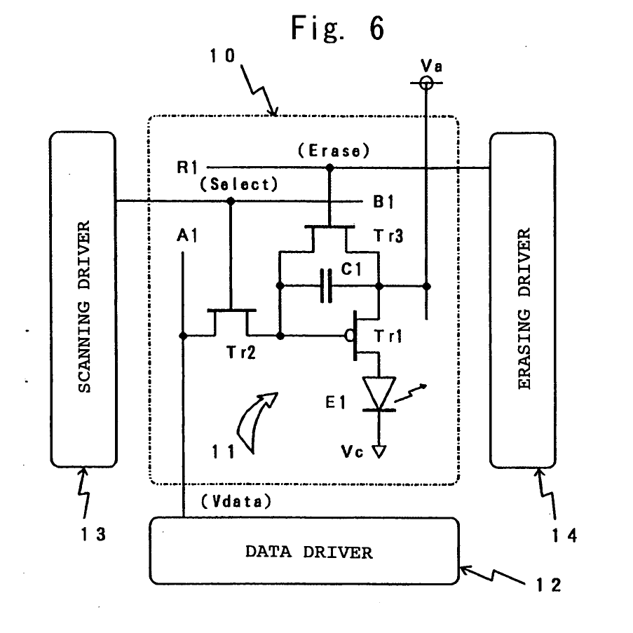

A drive device for a light-emitting display panel according to the present invention will be described below with reference to embodiments shown in the accompanying drawings. FIG. 6 shows a pixel arrangement of a display panel which can be preferably employed in the present invention. The pixel arrangement uses an ON drive scheme called SES (Simultaneous Erasing Scan) which effectively realize time-division grayscale expression.

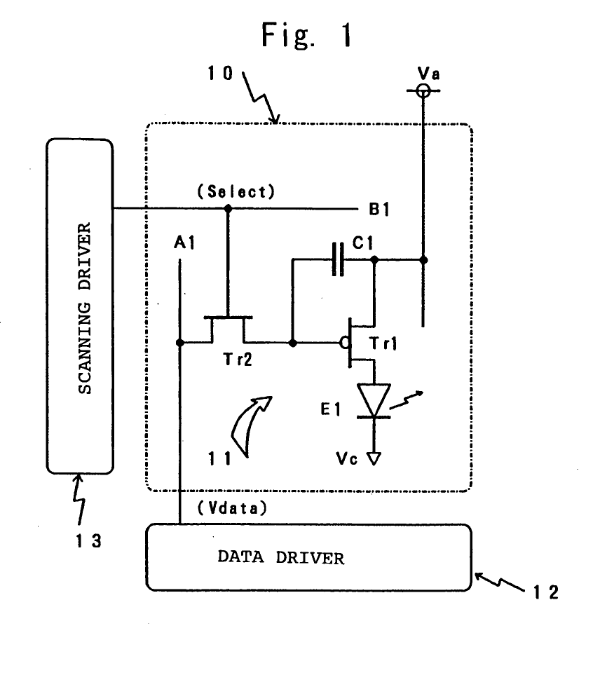

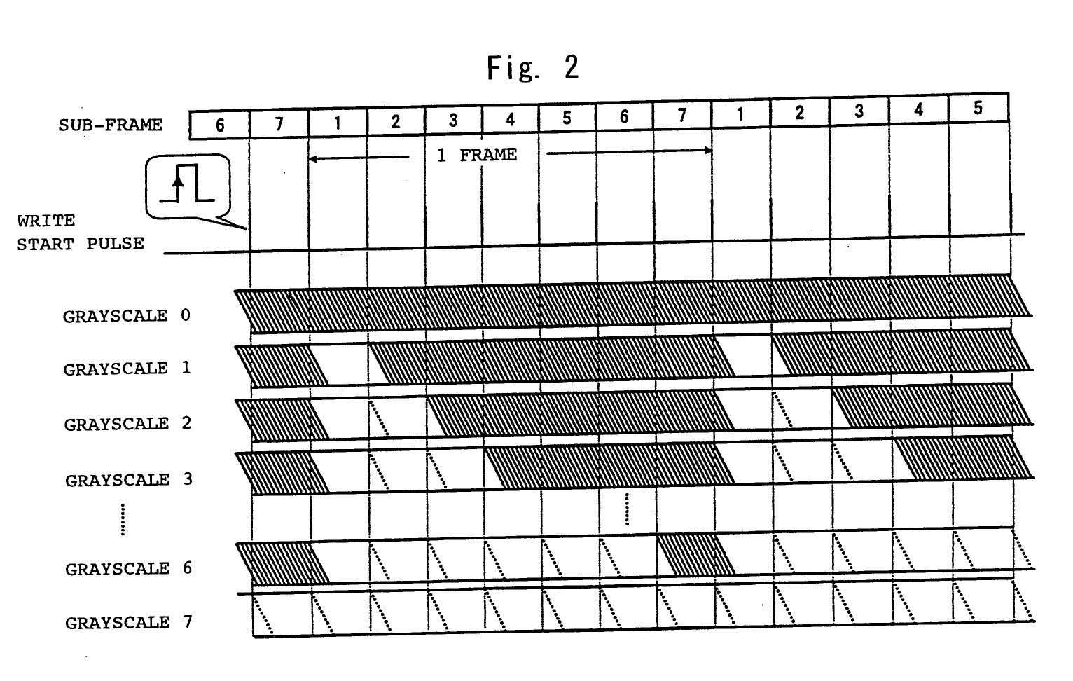

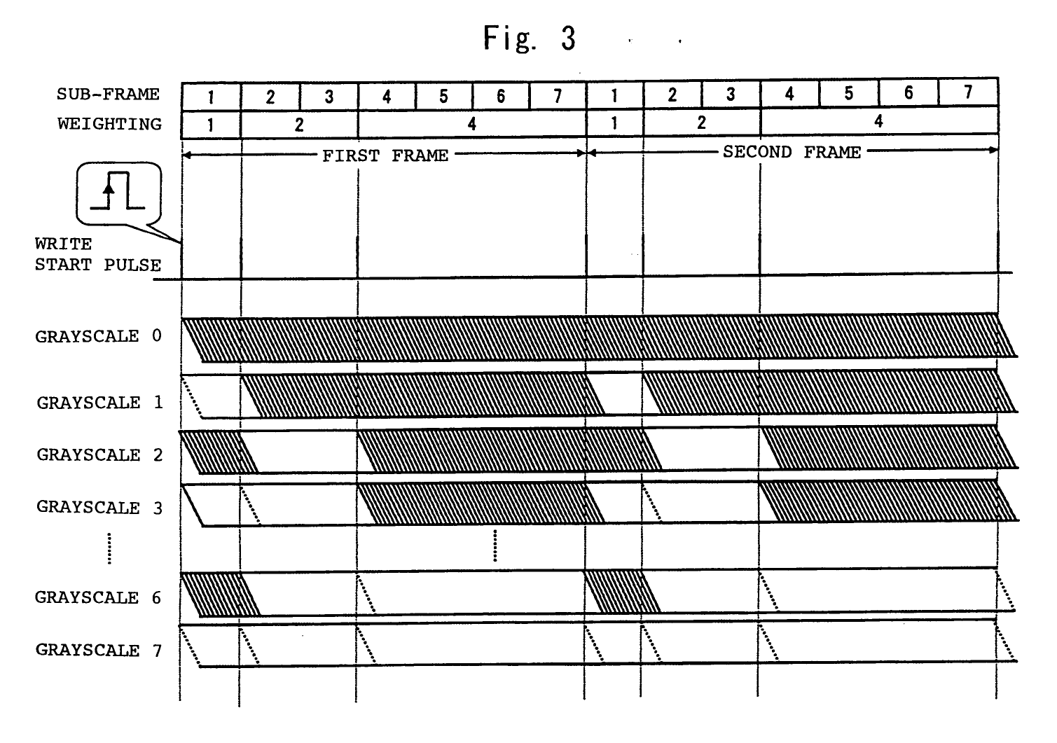

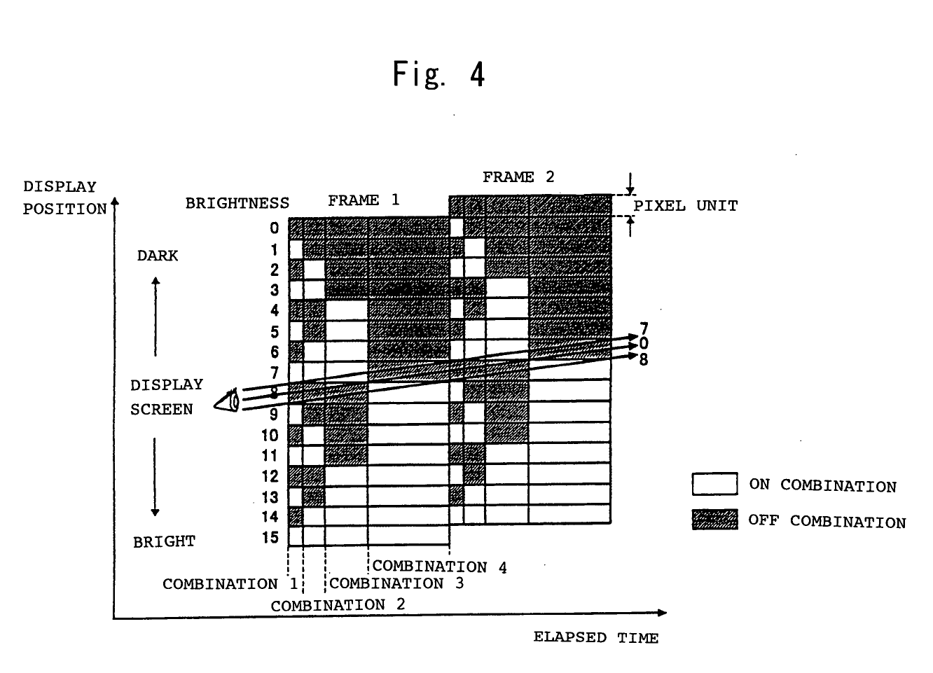

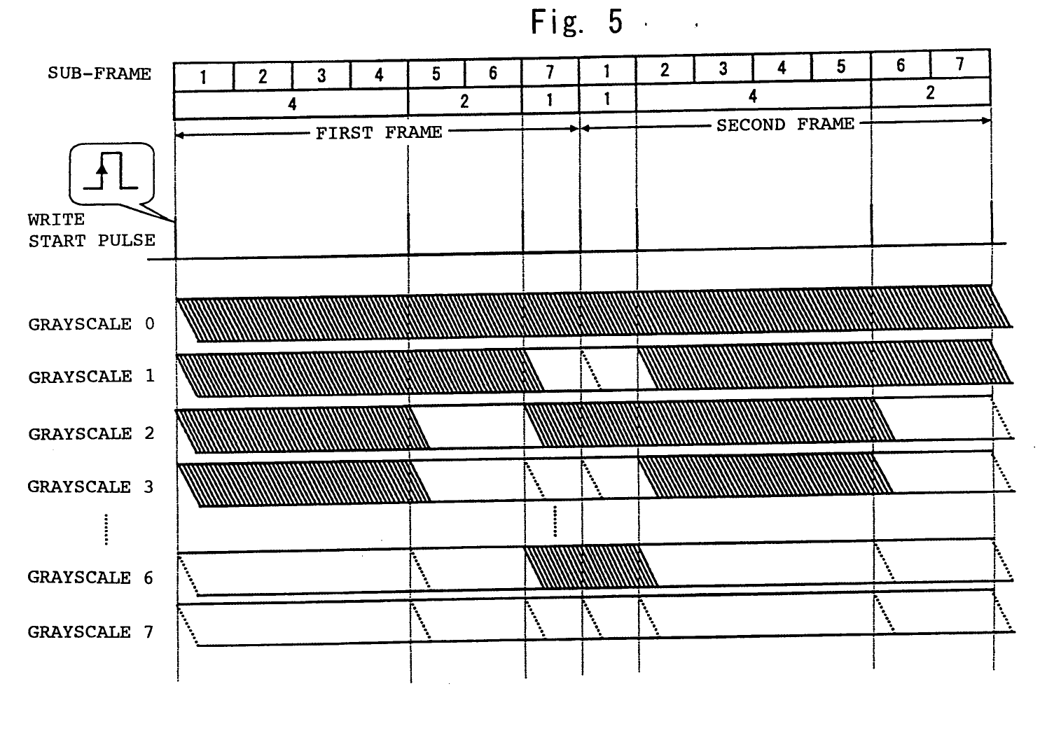

The pixel arrangement shown in FIG. 6 is obtained by adding an erasing transistor Tr3 to the conductance-controlled pixel arrangement described on the basis of FIG. 1. The same reference numerals as in FIG. 1 denote elements having the same functions in FIG. 6, a description thereof will be omitted.

The source and the drain of the erasing transistor Tr3 are connected to ends of the light-emission maintaining capacitor C1. The gate of the erasing transistor Tr3 is designed such that an erase signal Erase is supplied from an erasing driver 14 to the gate. The transistor Tr3 which receives the erase signal Erase is immediately turned on, electronic charges accumulated in a capacitor C1 are discharged, and the light-emitting drive transistor Tr1 is set in a cutoff state. For this reason, an EL element E1 is turned off.

Therefore, the pixel arrangement shown in FIG. 6 functions as an ON period control unit which supplies erase signals Erase on elapse of ON periods respectively set for sub-frames (to be described later) to forcibly turn off EL elements serving as light-emitting elements.

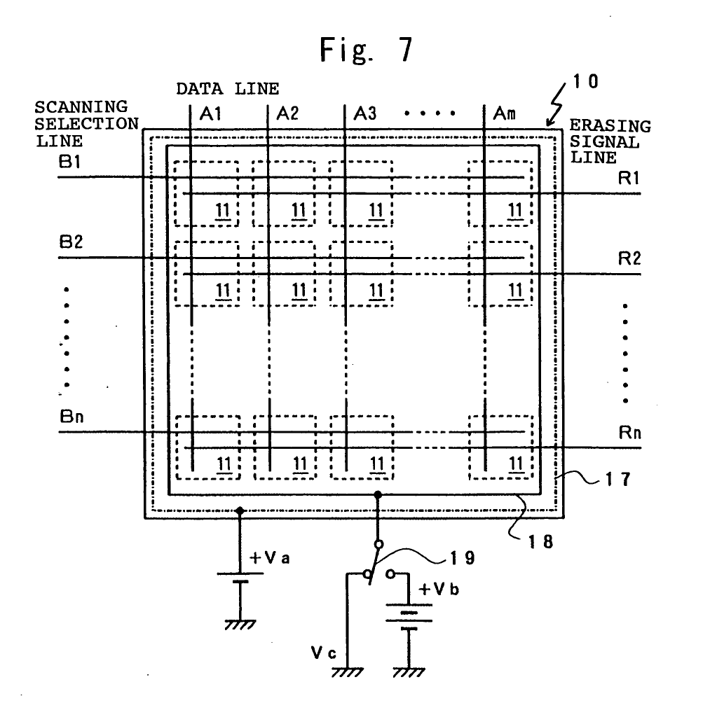

FIG. 7 typically shows a display panel 10 in which pixels 11 are arranged in the form of a matrix. At the crossing positions of data lines A1 to Am, scanning selection lines B1 to Bm, and erasing signal lines R1 to Rn, the pixels 11 of the circuit arrangement show in FIG. 6 are formed. In the arrangement, the sources of the light-emitting drive transistors Tr1 are connected to a common anode 17 shown in FIG. 7, and cathode terminals of the EL elements E1 are connected to a common cathode 18 shown in FIG. 7.

In the arrangement shown in FIG. 7, when a voltage of +Va is supplied from a power supply source to the common anode 17 to execute light-emitting control, a switch 19 is connected to a ground (voltage of Vc) as shown in FIG. 7. As will be described later, when a reverse bias voltage is applied to the EL elements E1 constituting the pixels, the switch 19 is switched to the power supply side +Vb.

In this case, the voltage of +Va and the voltage of +vb satisfy +Va<+Vb. Therefore, the switching operation of the switch 19 causes a reverse bias voltage to be applied between the common cathode 18 and the common anode 17. Therefore, the reverse bias voltage is applied to the EL element E1 through a portion between the source and the drain of the light-emitting drive transistor Tr1.

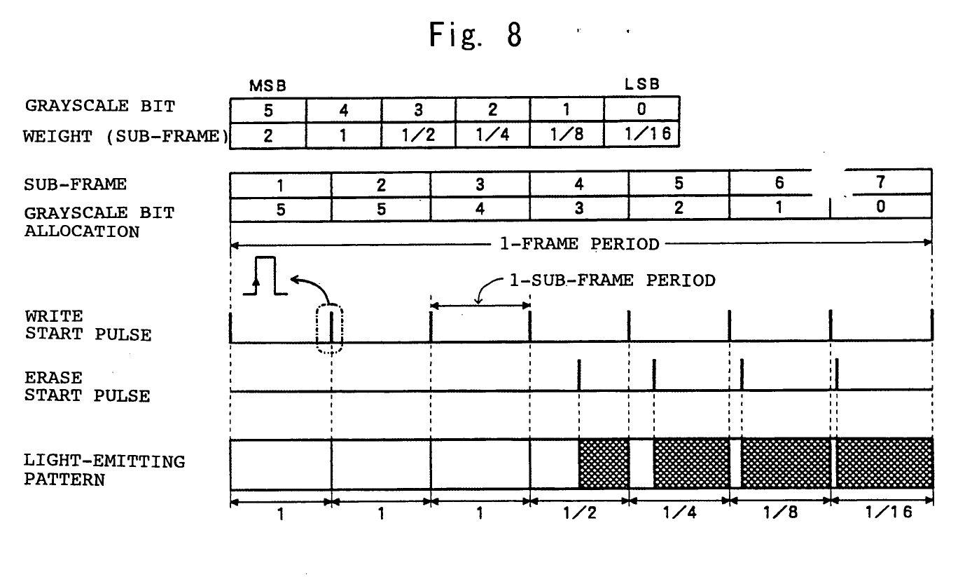

FIG. 8 shows an example of weighting grayscale control performed in the display panel 10 having the pixel arrangement of the SES drive scheme. As shown in FIG. 8, sub-frame periods in which pixels are driven to emit light in response to grayscale bits “5” to “0” are allocated as weights. For example, when the grayscale bit is “5”, two sub-frame periods are allocated as ON periods. For example, the grayscale bit is “0”, a 1/16 period of a 1-sub-frame period is allocated as an ON period.

A 1-frame period is divided into sub-frames of seven equal periods as indicated by sub-frame numbers “1” to “7”. Furthermore, in the aspect shown in FIG. 8, a grayscale bit for setting an ON period as described above is allocated to each sub-frame. For example, the grayscale bit “5” is allocated to first and second sub-frames. The grayscale bit “4” is allocated to a third sub-frame. Subsequently, similarly, the grayscale bit “0” is allocated to sub-frame number “7”, as a 1/16 weight in a 1-frame period.

Therefore, in the first sub-frame, the fifth grayscale bit is allocated to execute an ON operation of a sub-frame having weight 1. For this reason, at the start of the first sub-frame, a write start pulse shown in FIG. 8 is generated, and a scanning selection signal Select is supplied to the gate of a scanning selection transistor Tr2 by a scanning drive 13 shown in FIG. 6. Therefore, the capacitor C1 is electrically charged on the basis of a data signal Vdata from the data driver 12 at this time. The light-emitting drive transistor Tr1 supplies a drive current to the EL element E1 on the basis of a charging voltage to the capacitor, thereby driving the EL element E1 to emit light.

Even in the next second sub-frame, the fifth grayscale bit is allocated, and an ON operation of the sub-frame having weight 1 is also executed. The operation performed at this time is the same as the operation in the first sub-frame. In this case, for example, in a fourth sub-frame, the third grayscale bit is allocated. In this case, turn-on control is performed in a period ½ the sub-frame period. More specifically, a write start pulse is supplied at the start of the fourth sub-frame.

When the period ½ the sub-frame has elapsed, as shown in FIG. 8, an erasing start pulse is generated, and an erase signal Erase is supplied from the erasing driver 14 shown in FIG. 6 to the gate of the erasing transistor Tr3 to turn one the erasing transistor Tr3. Therefore, electronic charges accumulated in the capacitor C1 are discharged, and the light-emitting drive transistor Tr1 is immediately set in an offset state, so that the EL element E1 is turned off.

In the fifth and subsequent sub-frames, by the same operations as described above, turn-on control of EL elements based on weights allocated to the respective sub-frames is executed. For this reason, in a control state of the highest grayscale (brightest), the EL elements are ON-driven in a blank part indicated as a light-emitting pattern in FIG. 8. Therefore, according to the example shown in FIG. 8, 64-grayscale expression can be performed by 6 bits.

According to the weighting sub-frame method, as has been described above, grayscale expression is performed by combinations of time-discrete light emission. For this reason, it is understood pseudo contour noise cannot be suppressed from being generated. However, according to experiment and verification by the present inventor, it was found that the pseudo contour noise is not perceived when a frame frequency is set at 100 Hz or more.

More specifically, the following fact became clear. That is, when a frame frequency was gradually increased by employing the weighting sub-frame method to verify a degree of perception of pseudo contour noise, pseudo contour noise was not conspicuously perceived by most people at a frame frequency of 80 to 90 Hz, and pseudo contour noise is not perceived by all people at a frame frequency of 100 Hz or more. Therefore, according to the first aspect described above, pseudo contour noise generated in the first aspect and pseudo contour noise generated in the second aspect could be effectively suppressed. Furthermore, the same result could be obtained regardless of the number of sub-frames when a 1-frame period was time-divided with selection of the number of grayscale bits.

On the other hand, with an increase in frame frequency, a scanning selection frequency or the like must be also increased. Therefore, a problem in design of a drive circuit system, a problem in cost, a problem in power consumption, and the like are posed. For this reason, it can be understood that the frame frequency to cope with a power consumption is preferably set within a range of 100 Hz to 150 Hz in practical use.

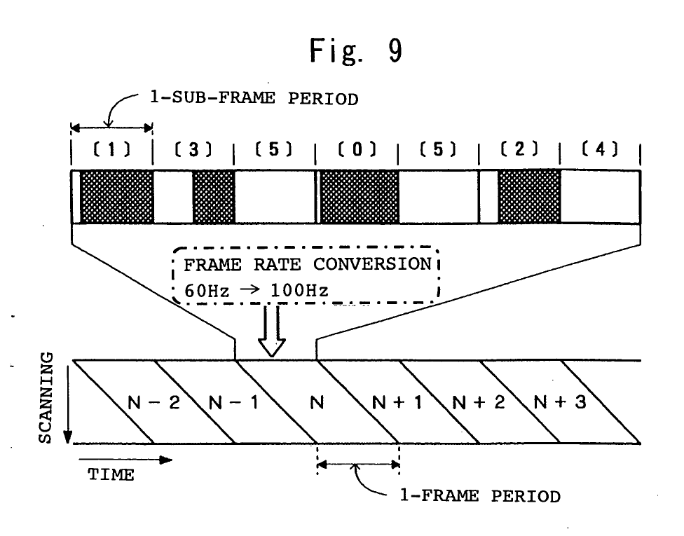

FIG. 9 shows the first embodiment according to the present invention when a video signal (frame frequency of 60 Hz) based on, e.g., NTSC system is displayed on a light-emitting display panel operated at a frame frequency of 100 Hz.

In the example shown in FIG. 9, an allocation order of grayscale bits to sub-frames is set to be different from that in the example shown in FIG. 8. More specifically, as shown by parenthetic grayscale bits respectively allocated to sub-frames as 1→3→5→0→5→2→4 in FIG. 9, sub-frames corresponding to grayscale bits “5” and “4” ON-controlled throughout a 1-sub-frame period are separately arranged in a 1-frame period such that the sub-frames are not continuously generated. A video signal shown in FIG. 9 and having a frame frequency of 60 Hz is converted in a frame rate and then supplied to the light-emitting display panel 10 operated at a frame frequency of 100 Hz.

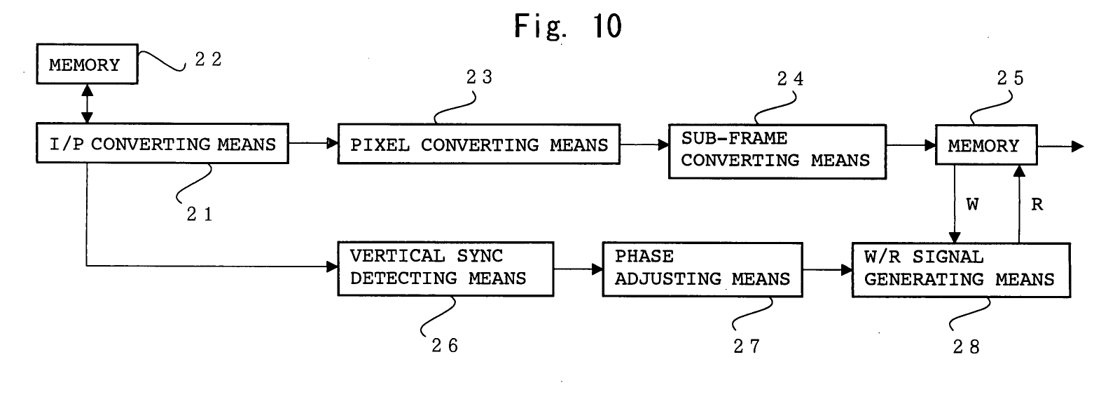

FIG. 10 shows an example of the frame rate converting unit by a block diagram. The video signal based on the NTSC system is an interlace signal. The interlace signal is supplied to an I/P converting unit 21 to convert a video signal into a progressive signal. In the I/P converting unit 21, information of a front field and information of a rear field are written in a memory 22, an interpolation line is synthesized from information of upper and lower scanning lines in the respective fields to convert the video signal into a progressive signal.

The progressive signal from the I/P converting unit 21 is supplied to a pixel converting unit 23. In the pixel converting unit 23, an operation of digitally increasing or reducing the number of pixels in accordance with the pixels arranged in the column and row directions of the display panel 10 is performed. An output from the pixel converting unit 23 is supplied to a sub-frame converting unit 24 to execute an operation of rearranging video signals from the pixel converting unit 23 into signals desired in the display panel 10.

On the other hand, a vertical sync signal synchronized with a video signal supplied to the I/P converting unit 21 is detected by a vertical sync signal detecting unit 26. The vertical sync signal is adjusted in phase by a phase adjusting unit 27 and then supplied to a write/read (W/R) signal generating unit 28. A write signal W generated by the write/read (W/R) signal generating unit 28 is synchronized with an original video signal to be converted in a frame rate. In response to the write signal W, the video signal from the sub-frame converting unit 24 is written in a memory 25. In response to a read signal R corresponding to a frequency depending on the degree of conversion in a frame rate, a pixel data signal is read from the memory 25. The pixel data signal is output as a video signal used in the display panel 10.

As described above, according to the light-emitting display panel 10 operating at a frame frequency of 100 Hz, it was verified that, although a weighting sub-frame method was employed as in the arrangement pattern of sub-frames shown in FIG. 9, pseudo contour noise cannot be perceived. It was verified that not only pseudo contour noise generated in the first aspect described above but also pseudo contour noise generated in the second aspect could be effectively suppressed in human visual perception.

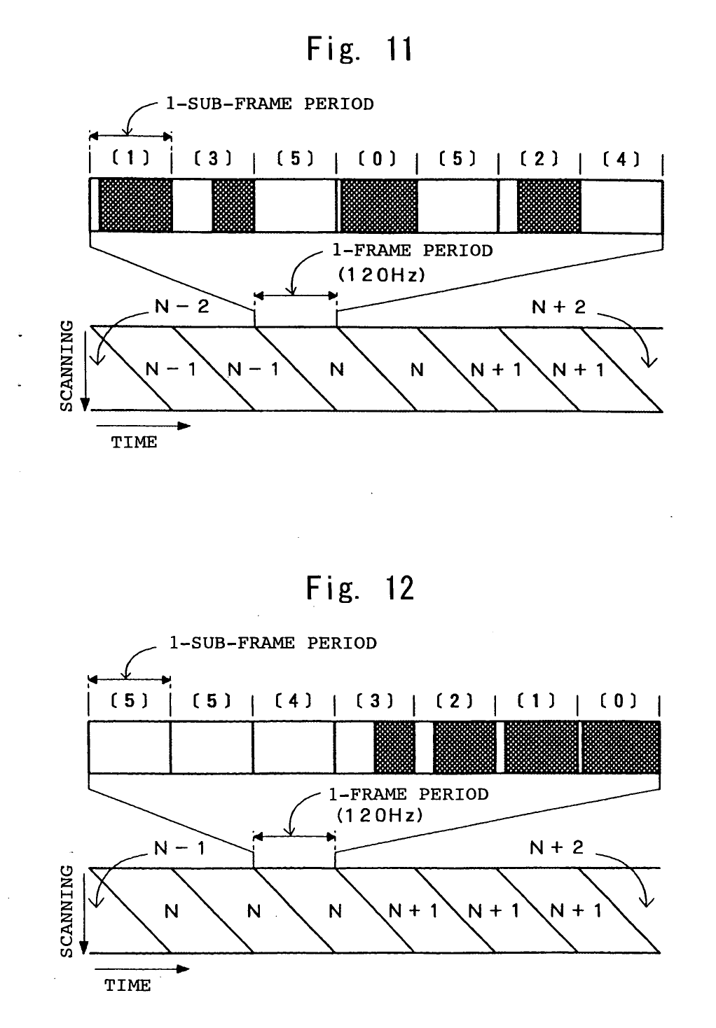

FIG. 11 shows a second embodiment of the present invention. Even in an example shown in FIG. 11, the same allocation arrangement of grayscale bits to sub-frames as in the example described in FIG. 9 is employed. In the embodiment shown in FIG. 11, light-emitting display based on the same image data corresponding to a 1-frame period is designed to be continuously performed for two frames.

More specifically, in the embodiment shown in FIG. 11, as has been described above, it is assumed that a progressive video signal based on the NTSC system is used, and a video signal having a frame frequency of 60 Hz is continuously displayed in two frames. According to this, the display panel 10 is driven at a frame frequency of 120 Hz. Even in the embodiment, as in the embodiment shown in FIG. 9, pseudo contour noise can be effectively suppressed in human perception.

FIG. 12 shows a third embodiment according to the present invention. In an example shown in FIG. 12, the same allocation arrangement of grayscale bits to sub-frames as in the example shown in FIG. 8 is employed. The embodiment shown in FIG. 12 is designed such that light-emitting display based on the same image data corresponding to a 1-frame period is continuously performed in three frames.

More specifically, in the embodiment shown in FIG. 12, it is assumed that a video signal having a frame frequency of 40 Hz is continuously displayed in three frames to drive the display panel 10 at a frame frequency of 120 Hz. Also in the embodiment, as in the embodiments shown in FIGS. 9 and 11, pseudo contour noise can be effectively suppressed in human perception.

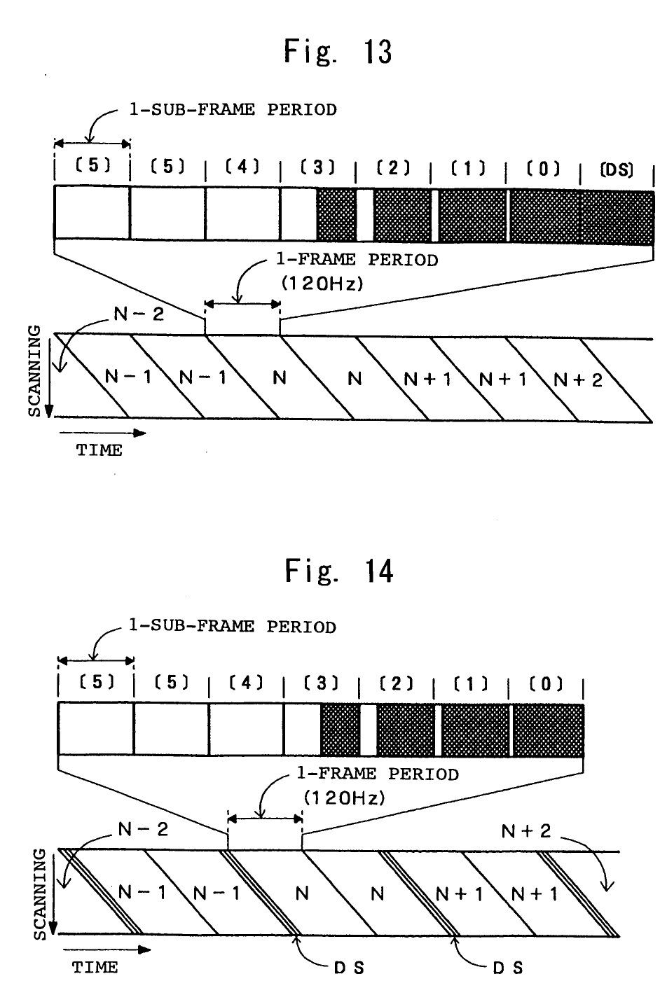

FIG. 13 shows a fourth embodiment according to the present invention. The fourth embodiment is designed such that a 1-frame period includes a dummy sub-frame DS to apply a reverse bias voltage to EL elements constituting pixels. More specifically, in the example shown in FIG. 13, the same allocation arrangement of grayscale bits to sub-frames as in the example shown in FIG. 12 is employed. Furthermore, the dummy sub-frame DS is added to the end of the 1-frame period, and one frame is divided into 8 sub-frames including the dummy sub-frame DS.

In the example shown in FIG. 13, the dummy sub-frame DS is formed by equally dividing a 1-frame period by 8 as in another sub-frame period. In the dummy sub-frame DS, the erasing transistor Tr3 shown in FIG. 6 is turned on at the start of the dummy sub-frame, and an EL element E1 of a pixel corresponding to the erasing transistor Tr3 is set in an off state in elapse of the dummy sub-frame period. In the example shown in FIG. 13, a video signal having a frame frequency of 60 Hz is continuously displayed in two frames, so that the display panel 10 is driven at a frame frequency of 120 Hz.

It is known that a voltage in reverse direction (reverse bias voltage) irrelevant to light emission is sequentially applied to the EL element E1 to make it possible to elongate the lifetime of the EL element (for example, see Japanese Patent Application Laid-Open No. 2002-169510). It is also known that a reverse bias voltage is applied to the EL element to make it possible to self-repair a leak phenomenon of the element (see Japanese Patent Application Laid-Open No. 2001-117534).

As in the configuration shown in FIG. 7, in the configuration in which a circuit arrangement of the pixels 11 are connected between the common anode 17 and the common cathode 18, at a timing at which all the pixels 11 arranged on the display panel 10 are turned off, the reverse bias voltage must be applied. However, since scanning selection timings of the pixels 11 sequentially shift in the direction of elapse of time in accordance with scanning selection lines B1 to Bn, in the period of the dummy sub-frame DS, a timing at which all the pixels 11 on the display panel 10 are turned off cannot be obtained. More specifically, the reverse bias voltage cannot be simultaneously applied to the EL elements of the pixels.

In the embodiment shown in FIG. 13, the dummy sub-frame DS is arranged immediately after a sub-frame to which a grayscale bit at which a pixel is turned off is allocated in the period of one sub-frame. More specifically, in the embodiment shown in FIG. 13, the dummy sub-frame DS is arranged immediately after a sub-frame to which a grayscale bit “0” at which an ON period is controlled to be the shortest ON period is allocated.

According to the arrangement state of the dummy sub-frame DS, within a period in which the sub-frame to which the grayscale bit “0” is allocated and the dummy sub-frame DS continue, a timing at which all the pixels 11 are turned off can be obtained, so that the device can be driven and controlled to apply a reverse bias voltage to the EL elements of the pixels at the timing.

In this case, for example, the dummy sub-frames DS may be arranged immediately after the sub-frames to which the grayscale bits, “1” to “3” are allocated. However, as especially shown in FIG. 13, the dummy sub-frame DS is desirably arranged immediately after a sub-frame to which the grayscale bit “0” at which an ON period is controlled to be the shortest ON period is allocated. In this manner, a sufficient application period of the reverse bias voltage can be set. The application of the reverse bias voltage can be realized such that, as has been described on the basis of FIG. 7, the switch 19 is switched to a voltage source +Vb side.

As described above, since the dummy sub-frame DS is arranged immediately after a sub-frame to which a grayscale bit at which a pixel is turned off in the period of one sub-frame, the period of the dummy sub-frame DS need not be set to be longer than another sub-frame period. Therefore, according to the arrangement state of the dummy sub-frame DS shown in FIG. 13, an ON rate of pixels can be prevented from being sacrificed. Even in the embodiment shown in FIG. 13, an advantage of effectively suppressing pseudo contour noise in human perception can be achieved.

As has been described above, when a reverse bias voltage is applied to an EL element constituting a pixel to self-repair a leak phenomenon of the EL element, a relatively large current must be instantaneously supplied in the application direction of the reverse bias voltage of the EL element. For this reason, the pixel arrangement shown in FIG. 6 desirably includes a diode serving as a passive element to bypass the light-emitting drive transistor Tr1 or a TFT serving as an active element.

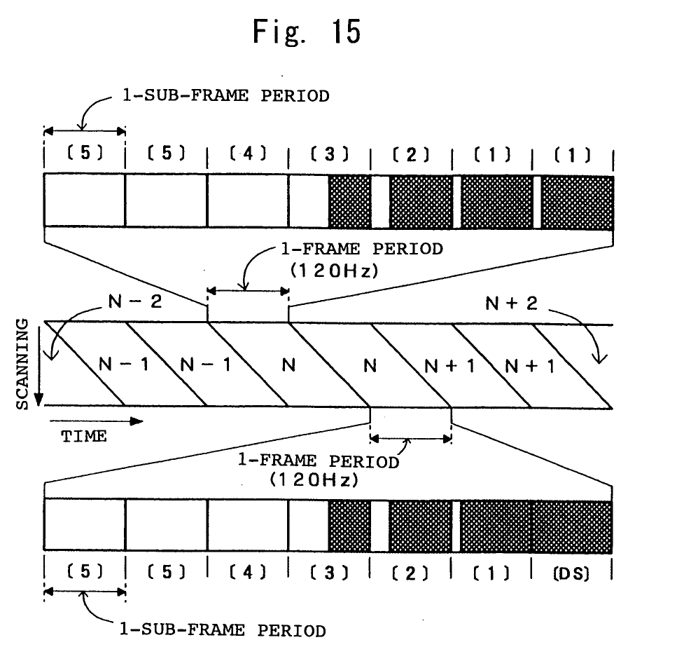

FIG. 14 shows a fifth embodiment according to the present invention, a configuration including dummy sub-frames DS to apply a reverse bias voltage to EL elements constituting pixels in a plurality of frames is employed. In this case, also in the example shown in FIG. 14, as in the example shown in FIG. 13, a video signal having a frame frequency of 60 Hz is continuously displayed in two frames, so that the display panel 10 is driven at a frame frequency of 120 Hz.

In the embodiment shown in FIG. 14, a dummy sub-frame is not included in a frame previous to the video signal continuously displayed in two frames, the same allocation arrangement of grayscale bits to sub-frames as in the example shown in FIG. 12 is employed. In a frame next to the video signal continuously displayed in two frames, the same allocation arrangement of grayscale bits to sub-frames including the dummy sub-frame DS as in the example shown in FIG. 13 is employed.

According to the embodiment shown in FIG. 14, the dummy sub-frame DS is set every two frames to make it possible to apply a reverse bias voltage to EL elements constituting pixels. For this reason, the same working effect as in the embodiment described in FIG. 13 can be obtained. In the embodiment, since a dummy sub-frame DS is set every two frames or plurality of frames, an ON rate of pixels can be improved in comparison with the embodiment shown in FIG. 13 in which a dummy sub-frame is set every frame.

FIG. 15 shows a sixth embodiment according to the present invention. Also in this embodiment, it is assumed that light-emitting display based on the same image data is continuously performed in N frames. More specifically, the embodiment shown in FIG. 15 shows an example in which a video signal having a frame frequency of 60 Hz is displayed in two frames, so that the display panel 10 is driven at a frame frequency of 120 Hz.

In this case, in a frame period before a video signal is continuously displayed in two frames, in place of a sub-frame (i.e., a sub-frame to which a grayscale bit “0” is allocated) in which an ON period is controlled to be the shortest period, a sub-frame (i.e., a sub-frame to which a grayscale bit “0” is allocated) in which an ON period is controlled to be the second shortest period is set. On the other hand, in a frame period after the video signal is continuously displayed in the two frames, a dummy sub-frame DS is set in place of a sub-frame (i.e., a sub-frame to which a grayscale bit “0” is allocated) in which an ON period is controlled to be the most shortest period.

According to the embodiment shown in FIG. 15, grayscale display is performed by summing (average per frame) of ON period in the frames before and after the video signal is continuously displayed in two frames, and faithful grayscale control obtained by weighting a power-of-two brightness in the periods can be performed. According to the embodiment shown in FIG. 15, the numbers of divided sub-frames in the frames before and after the video signals is continuously displayed can be made equal to each other. For this reason, the configuration of drive control can be simplified.

Even in the embodiment shown in FIG. 15, a dummy sub-frame DS is set every two frames or plurality of frames. For this reason, an ON rate of pixels can be improved in comparison with the embodiment shown in FIG. 13 in which a dummy sub-frame is set every frame. Furthermore, an advantage of effectively suppressing pseudo contour noise in human perception can be similarly achieved.

In the embodiment described above, an organic EL element is used as a light-emitting device. However, the light-emitting element is not limited to the organic EL element, and a current-dependent light-emitting element can be used. The drive device for the display panel is applied to not only the mobile telephone and the PDA described at the front, but also various electronic machines requiring a display device of this type, so that the working effect described above can be directly achieved.

What is claimed is:

1. A drive device for a display panel in which pixels respectively including light-emitting elements are arranged at crossing positions of a plurality of data lines and a plurality of scanning selection lines in the form of a matrix,
wherein a 1-frame period is time-divided into a plurality of sub-frame periods, grayscale bits for setting ON periods are allocated to the sub-frames, respectively, to perform weighting, grayscale display is performed by summing the ON periods of the sub-frames, and a frame frequency of the 1-frame period is set within a range of 100 Hz to 150 Hz.

2. The drive device for a light-emitting display panel according to claim 1, comprising ON period control means which forcibly turn off the light-emitting element on elapse of an ON period set for each of the sub-frames.

3. The drive device for a light-emitting display panel according to 1, wherein light-emitting display based on the same image data corresponding to a 1-frame period is continuously performed in N frames (N is a natural number).

4. The drive device for a light-emitting display panel according to 1, wherein the 1-frame period is set to include a dummy frame for applying a reverse bias voltage to the light-emitting element.

5. The drive device for a light-emitting display panel according to 1, wherein a plurality of frames are set to include a dummy sub-frame for applying a reverse bias voltage to the light-emitting element.

6. The drive device for a light-emitting display panel according to 3, wherein, when light-emitting display based on the same image data is continuously performed in N frames, a sub-frame in which an ON period is controlled to be the second shortest ON period is set in place of a sub-frame in which an ON period is controlled to be the shortest ON period in a 1-frame period in the N frames, and a dummy sub-frame is set in place of the sub-frame in which an ON period is controlled to be the shortest ON period in another frame period of the N frames.

7. The drive device for a light-emitting display panel according to any one of claims 4 to 6, wherein the dummy sub-frame is set immediately after a sub-frame in which pixels are turned off in a period of one sub-frame.

8. The drive device for a light-emitting display panel according to 7, wherein the dummy sub-frame is set immediately after a sub-frame in which an ON period is controlled to be the shortest ON period.

9. The drive device for a light-emitting display panel according to 1, wherein the light-emitting element is constituted by an organic EL element having at least one light-emitting function layer.

10. An electronic machine, wherein the drive device for a display panel according to claim 1 is mounted on the electronic machine.
